(19) United States
(12) Patent Application Publication
(10) Pub. No.: US 2003/0069784 A1
(43) Pub. Date: Apr. 10, 2003

(54) Integrated billing of vehicle-related services using ad-hoc networks

(75) Inventors: Dwip N. Banerjee, Austin, TX (US); Rabindranath Dutta, Austin, TX (US); Ramamoorthy Karthikeyan, Austin, TX (US)

Correspondence Address: Duke W. Yee, Carstens, Yee & Cahoon, LLP, P.O. Box 802334, Dalles, TX, 75380, US

(73) Assignee: International Business Machines Corporation, Armonk, NY

(21) Appl. No.: 09/970,864

(22) Filed: Oct. 4, 2001

(51) Int. Cl. G06F 17/60

(52) U.S. Cl. 705/13

(57) ABSTRACT

A method, computer program, and data processing system for billing vehicle-related services using ad hoc networks is disclosed. A device associated with the vehicle operator is discovered in an ad hoc network. Billing information is obtained from the device, and the operator is billed for whatever services are being utilized at present (e.g., parking or a toll road).

### BACKGROUND OF THE INVENTION

1. Technical Field

The present invention relates generally to billing of vehicle-related services. More specifically, the present invention is directed toward automating the process of paying for services such as parking or toll roads through the use of ad hoc networking.

2. Description of Related Art

The use of radio-frequency identification (RFID) tag technology in providing vehicle-related services has become relatively widespread. Vehicle mounted RFID tags have been used for paying tolls at tollbooths and providing access to parking facilities, among other uses. RFID tags are passive memory devices that can be read by being placed in proximity to an RFID reader. For example, U.S. Pat. No. 5,809,142, to Hurta, et al., teaches a system in which an RFID transponder tag system in which a tag reader reads a monetary balance from an RFID transponder associated with the vehicle, decrements the balance to cover the cost of toll, then writes the new balance to the tag. They can also be programmed to hold account numbers for a debit account for parking or tolls, for instance, which can be debited each time the RFID tag is read. U.S. Pat. No. 5,819,234 to Slavin, et al., describes such as system.

RFID tags used for these purposes, however, are somewhat inconvenient in that they must be purchased separately and carried (either on one's person or through attachment to a vehicle). RFID tags are vulnerable to loss and theft and often can only be renewed by purchasing another tag.

Further, RFID tags do not allow for interactivity or programmability. For example, sometimes a charge is based upon the number of people in the vehicle, as is the case with some ferry boats. An RFID tag is not capable of providing that level of interactivity.

Automotive manufacturers, though, are adding supplemental communications features to modern vehicles. For example, General Motors' “OnStar” subsidiary reportedly sells wireless computing services for cars, including navigation systems and voice-activated Internet systems that allow drivers to check e-mail and receive news stories, stock quotes, weather and sports scores while in the car. www.onstar.com, Sep. 4, 2001. It is also reported that a number of car makers offer location-based and emergency services over networks using a “global system for mobile communication” (GSM) network.

Automobile communications systems such as “OnStar,” however, generally require special communications equipment installed within the car. Many cars today do not provide such communications features, so it would be helpful if a payment or billing system were available that could be used with existing automobiles, without the installation of special equipment in the automobile. Moreover, it would be helpful if the communications system could be used by a customer that switches between several vehicles.

What is needed, then, is a convenient way of paying for vehicle-related services that does not rely on the use of added tags or vehicle-installed equipment.

### SUMMARY OF THE INVENTION

The present invention provides a method, computer program, and data processing system for billing vehicle-related services using ad hoc networks. A device associated with the vehicle operator, such as a mobile telephone, portable digital assistant, or the vehicle itself, is discovered in an ad hoc network. Billing information is obtained from the device, possibly through an interactive process, and the operator is billed for whatever services are being utilized at present (e.g., parking or a toll road).

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is a diagram of a distributed data processing system in which the present invention may be implemented;

FIG. 1B is a diagram of a Bluetooth scatternet in accordance with a preferred embodiment of the present invention;

FIG. 2 is a block diagram of a data processing system suitable for use as a server in a preferred embodiment of the present invention;

FIG. 3 is a block diagram of a data processing system suitable for use as a client in a preferred embodiment of the present invention;

FIG. 4 is a diagram providing an overall view of a vehicle-related service billing system in accordance with a preferred embodiment of the present invention;

FIG. 5 depicts a number of user devices that may be used in accordance with a preferred embodiment of the present invention;

FIGS. 6-7 depict a process of billing a vehicle-related service from the point of a user, in accordance with a preferred embodiment of the present invention;

FIG. 8 is a diagram depicting a tollbooth using a billing system in accordance with a preferred embodiment of the present invention;

FIG. 9 is a diagram depicting a parking lot using a billing system in accordance with a preferred embodiment of the present invention;

FIG. 10 is a diagram depicting a traffic ticket payment system in accordance with a preferred embodiment of the present invention; and

FIG. 11 is a flowchart representation of a process of billing a user for a vehicle-related service in accordance with a preferred embodiment of the present invention.

### DETAILED DESCRIPTION OF THE PREFERRED EMBODIMENT

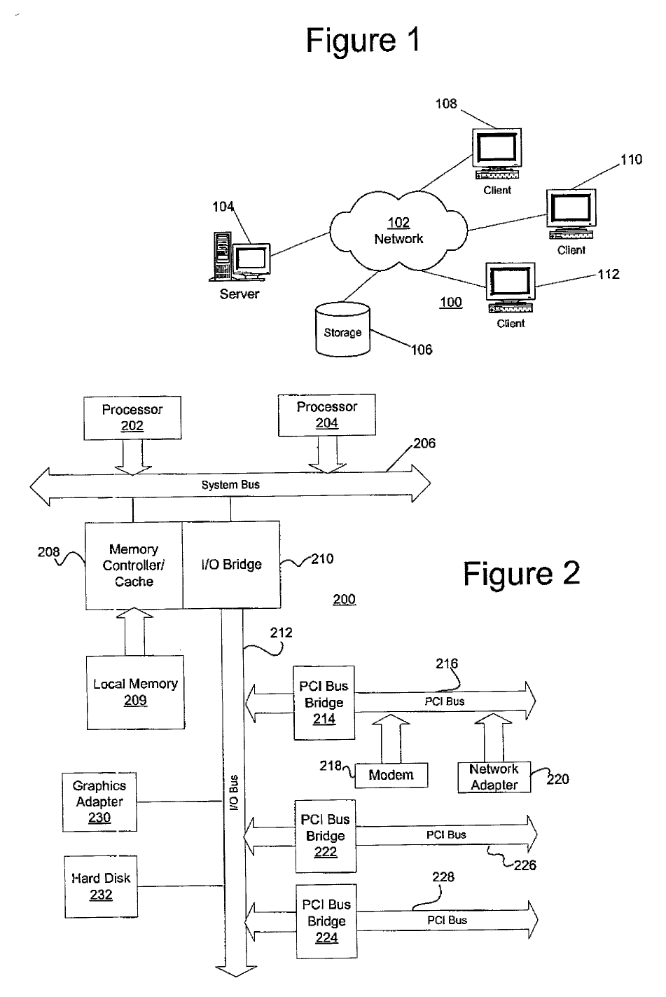

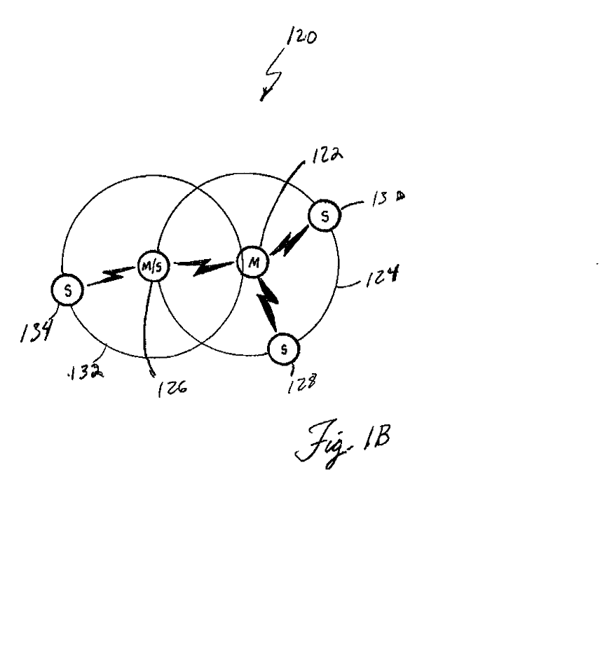

With reference now to the figures, FIG. 1A depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1A is intended as an example, and not as an architectural limitation for the present invention.

In a preferred embodiment of the present invention, data processing system 100 is implemented as or includes a wireless network. For example, a Bluetooth wireless network may be used in the peer-to-peer computing system of the present invention. Bluetooth is a wireless ad hoc network technology from the Bluetooth Special Interest Group. An ad hoc network, as used here, is a network that is established and reorganized dynamically as nodes within the network move in a physical environment. Bluetooth is an open standard for short-range transmission of digital voice and data between mobile devices (laptops, PDAs, phones) and desktop devices. Bluetooth supports point-to-point and multipoint applications. A Bluetooth radio is built into a small microchip and operates in a globally available frequency band ensuring communication compatibility worldwide. A tiny Bluetooth microchip, incorporating a radio transceiver, is built into digital devices. Bluetooth technology makes connections quickly and without the need for cable, as Bluetooth devices placed in proximity to one another will “discover” each other and establish a connection. The radio operates in a globally available frequency band, ensuring compatibility worldwide. Bluetooth facilitates fast and secure transmission of both voice and data, even when the devices are not within line of sight. Bluetooth technology supports both point-to-point and point-to-multipoint connections. Bluetooth has a link range that varies according to the signal strength chosen, from 10 meters to 100 meters, approximately.

Currently, up to seven ‘slave’ devices can be set to communicate with a ‘master’ radio in one device. Several of these ‘piconets’ can be established and linked together in ad hoc ‘scatternets’ to allow communication among continually flexible configurations. All devices in the same piconet have priority synchronization, but other devices can be set to enter at any time. The topology can best be described as a flexible, multiple piconet structure.

FIG. 1B is a diagram depicting a small scatternet 120. Master node 122 coordinates piconet 124, which contains slave nodes 126, 128, and 130. As Bluetooth relies on time-division multiplexing, master node 122, synchronizes slave nodes 126, 128, and 130 to eliminate signal interference. Piconet 124 is linked to piconet 132 through node 126, which is a slave in piconet 124 and the master in piconet 132. Piconet 132 contains one slave node 134.

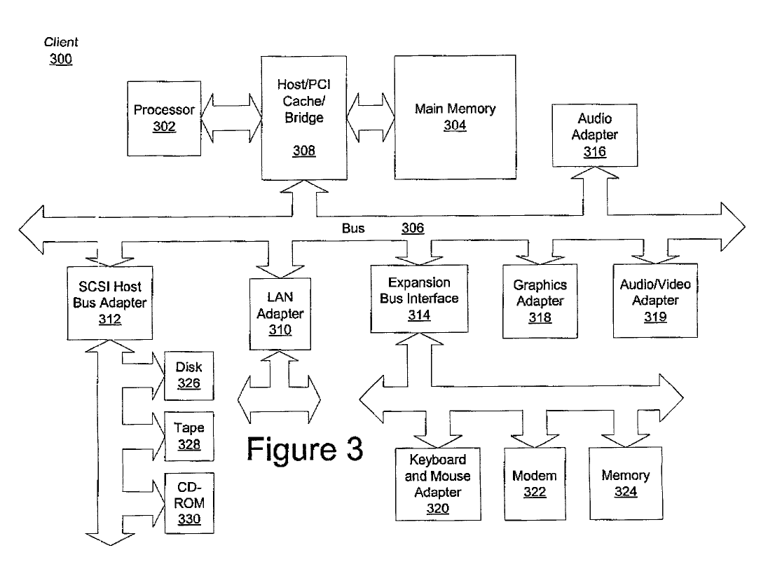

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) or Linux operating system.

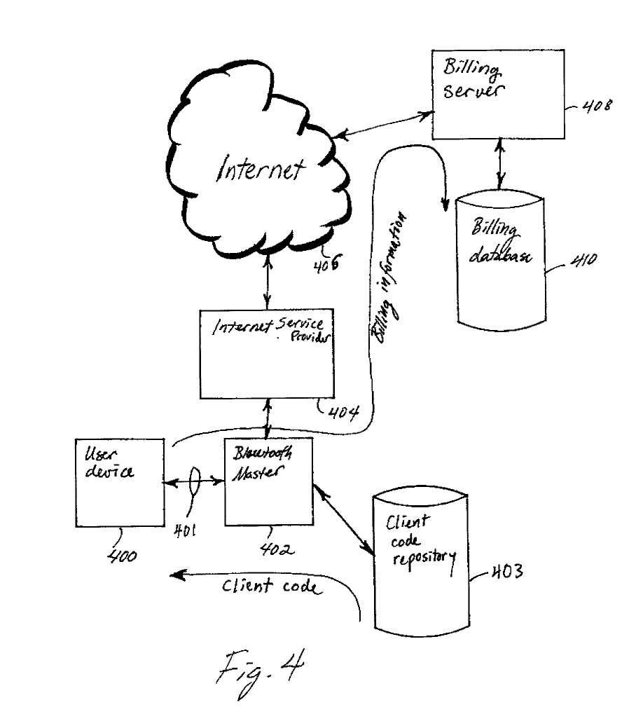

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

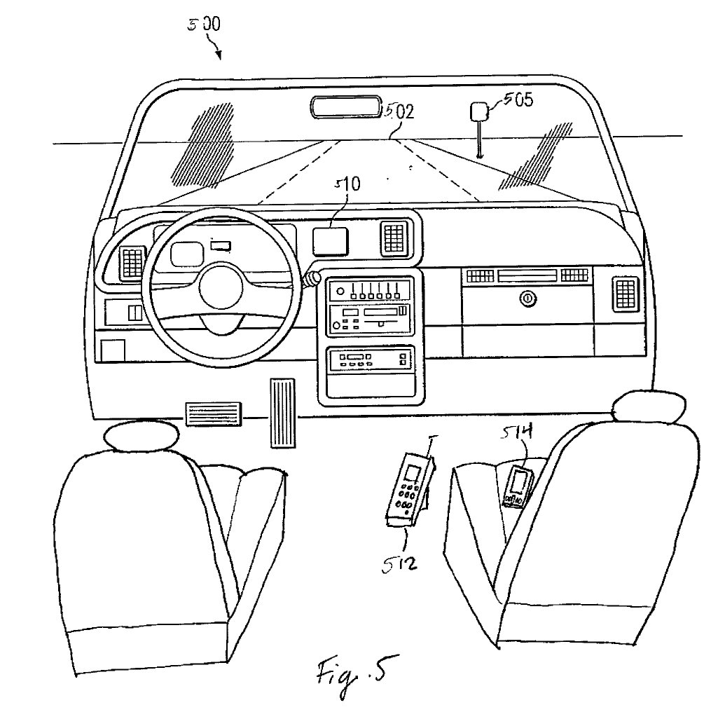

FIG. 4 is a diagram providing an overall view of a vehicle-based service billing system in accordance with a preferred embodiment of the present invention. User device 400 enters into a Bluetooth ad hoc network coordinated by Bluetooth master 402. Bluetooth master 402 is connected through Internet service provider 404 to Internet 406. Billing server 408 is connected to Internet 406 and transmits and receives data, including billing information, to/from user device 400.

When user device 400 comes into proximity with Bluetooth master 402, Bluetooth master 402 discovers user device 400. User device 400 preferably includes some kind of hypertext or other display software for displaying digital documents written in a structured markup language, such as HyperText Markup Language (HTML) or Wireless Markup Language (WML); such software may be downloaded to user device 400 from client code repository 403 upon Bluetooth master 402 first discovering and contacting user device 400, thereby allowing the software to be updated without requiring any intervention on the part of the user. Preferably, software downloaded from client code repository 403 will be written in a platform-independent language such as Java or Python, so that a single binary copy of the software may run on a variety of different user devices. Billing server 408 requests an account number, or other identification information used for identifying a party to be billed, from user device 400. This billing information will be matched to a billing record in billing database 410, where the transaction may be recorded. If any additional information is required from a user to complete the transaction, Bluetooth master 402 transmits a message to user device 400, to be displayed using the display software, requesting additional data. User device 400 then acquires the additional data from the user, preferably through some kind of form, such as an HTML form, and transmits a response to billing server 408. Billing server 408 either adds the amount to be billed to the user's balance of billed charges or debits a pre-paid account in the proper amount, then updates billing database 410 to reflect the billed charges.

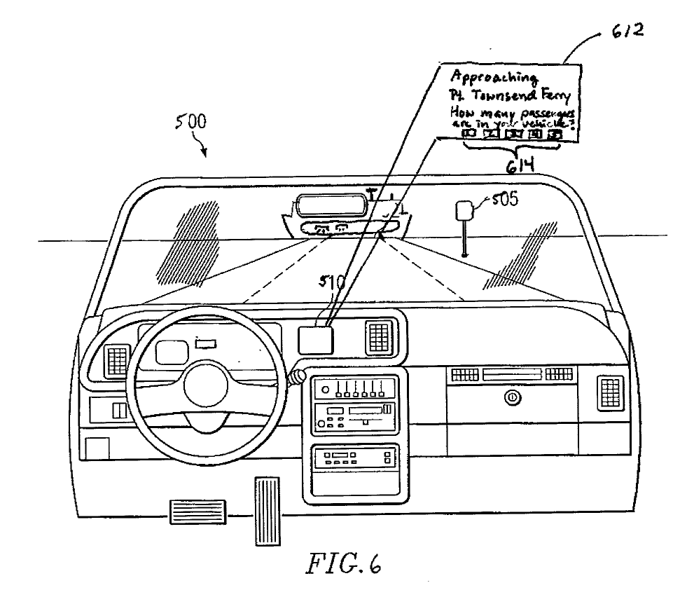

FIG. 5 depicts a variety of devices that may be used as the user device in accordance with a preferred embodiment of the present invention. One of the hallmarks of Bluetooth is the ability for the Bluetooth communications hardware, which generally requires a single integrated circuit, to be easily embedded into products. FIG. 5 depicts an assortment of these devices that may be used in accordance with a preferred embodiment of the present invention, but is not by any means to be construed as exhaustive of the various possibilities. Vehicle 500 is traveling along a road 502, having a road sign 505. Road sign 505 has a Bluetooth master device affixed to its back. As vehicle 500 approaches road sign 505, the Bluetooth master will discover the user devices (vehicle device 510, mobile telephone 512, and portable digital assistant (PDA) 514) associated with the driver of the vehicle. Only one of these devices need be communicated with, and a simple priority system may serve to determine which of the devices is actually communicated with (e.g., the vehicle has a higher priority than the PDA, the PDA has a higher priority than the telephone, etc.).

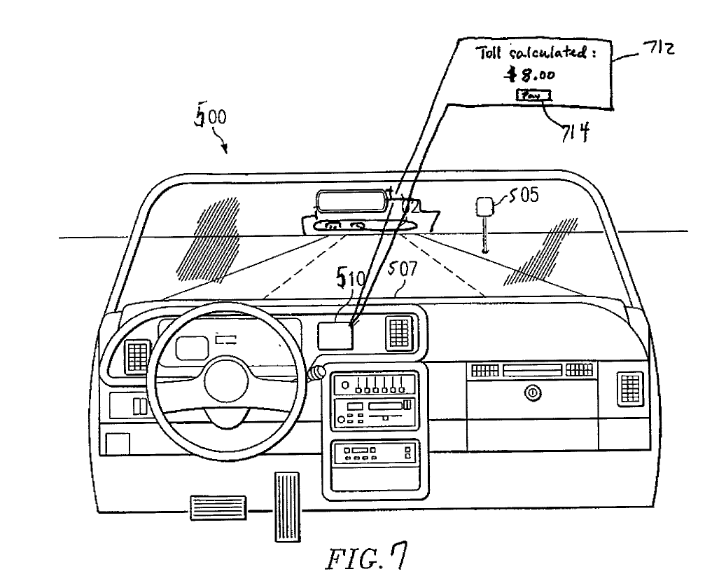

Whichever device is selected will transmit billing information through the Bluetooth master to the network-connected billing server, and then further interact with the billing server to complete the transaction. FIGS. 6 and 7 illustrate this process.

In FIG. 6, vehicle device 510 has been discovered by the Bluetooth master. Billing information has been requested of vehicle device 510 and transmitted to the billing server. Further information is being requested. A message (612) in a markup language (such as HTML) has been transmitted to vehicle device 510 and is displayed on a touch-sensitive screen of vehicle device 510. Message 612 is actually a form requesting that the driver provide the number of passengers in the car. Buttons 614 are displayed on vehicle device 510 and may be actuated by touching the screen. Touching an appropriate one of buttons 614 transmits a response to the billing server, and the billing server responds in FIG. 7 with message 712 displaying the calculated fee and providing a button 714 for authorizing payment. Once the user has touched button 714, a response will be sent by vehicle device 510 to the billing server and the billing server will update its database to indicate that the user has been billed for the transaction.

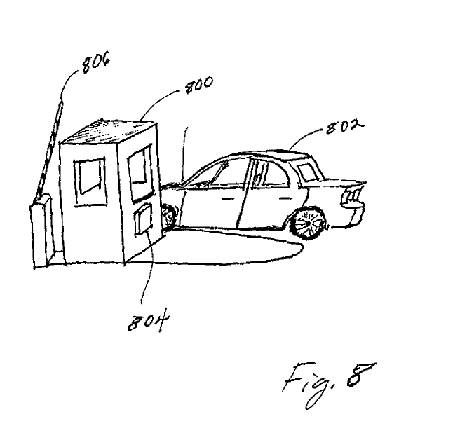

The billing system of the present invention is applicable in a variety of environments and applications. FIGS. 8-10 depict several of these applications. FIG. 8 is a diagram depicting a tollbooth 800 using a billing system in accordance with a preferred embodiment of the present invention. Automobile 802 is equipped with a Bluetooth client device, which enters into a Bluetooth ad hoc network with master device 804, attached to tollbooth 800. Automobile 802's client device transmits a request for access to master device 804 along with billing information. Master device 804 submits the information to a billing server, and when payment has been authorized, barrier arm 806 is lifted and automobile 802 is allowed to proceed.

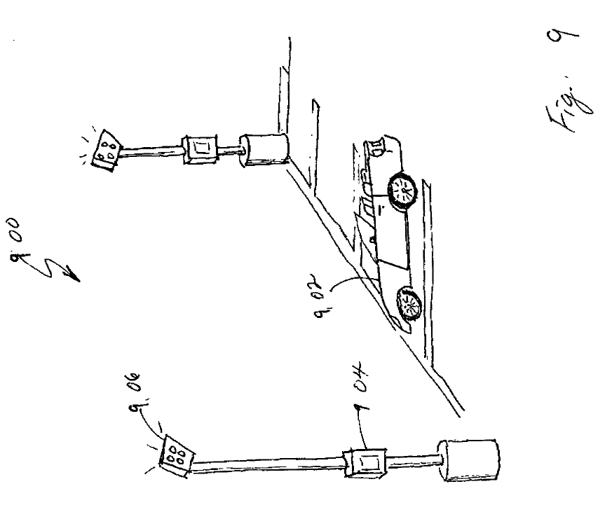

FIG. 9 is a diagram depicting a parking lot 900 using a billing system in accordance with a preferred embodiment of the present invention. Automobile 902 is equipped with a Bluetooth client device, which enters into a Bluetooth ad hoc network with master device 904, mounted on lamppost 906. Master device 904 can then monitor for automobile 902's presence within parking lot 900, and bill for automobile 902's elapsed parking time.

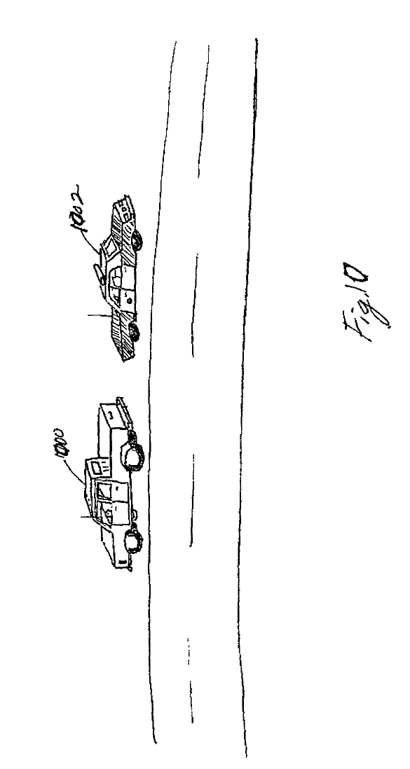

FIG. 10 is a diagram depicting a traffic ticket payment system in accordance with a preferred embodiment of the present invention. Truck 1000 has been caught speeding. The police officer in police cruiser 1002 has written a speeding ticket to the driver of truck 1000. The driver has a personal digital assistant (PDA) with a Bluetooth interface, and police car 1002 is equipped with a Bluetooth master device. The PDA will enter into a Bluetooth ad hoc network with police cruiser 1002. The driver of truck 1000 may use his/her PDA to electronically authorize payment through the ad hoc network connection with police cruiser 1002. The transmitted payment authorization may be retained within the memory of the master device in police cruiser 1002 and downloaded back at the police station or it may be immediately relayed via wireless link to a central “billing” server.

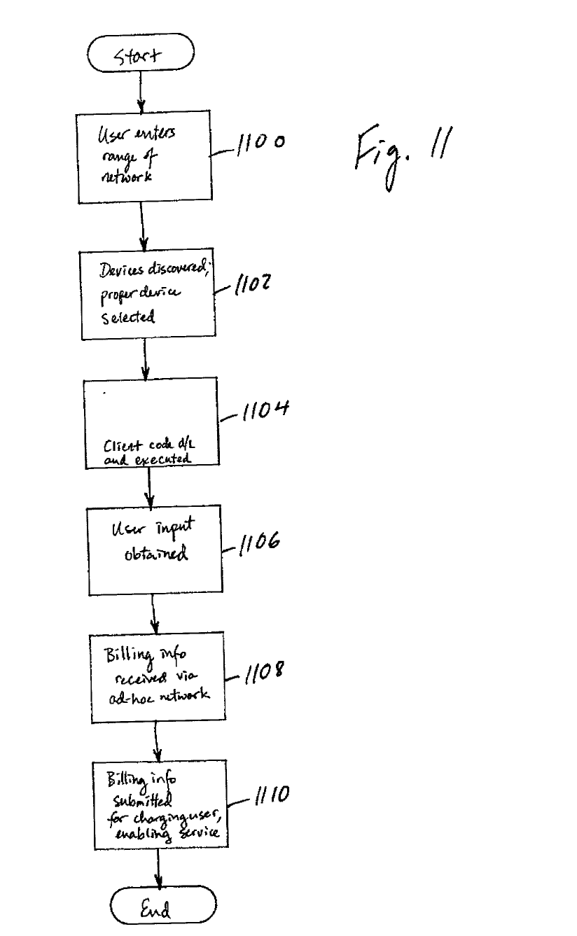

FIG. 11 is a flowchart representation of a process of billing a user for a vehicle-related service in accordance with a preferred embodiment of the present invention. First, the user (and user's ad hoc network-enabled device) enters the physical range of an ad hoc network (step 1100). The device is discovered by the network and the device discovers the network (step 1102). Any client code to be downloaded and executed on the device is then downloaded to the device for execution (step 1104). If additional user input is required, an appropriate form is displayed on the client device (step 1106). The device submits billing information and user responses, which are received by the billing server, so that the service may be charged to the user (step 1108). Finally, the user is charged for the services rendered by updating the database and the service is enabled, if necessary (e.g., the arm is lifted at a tollbooth) (step 1110).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the invention may be implemented using a different ad-hoc network standard, such as the IEEE 802.11 standard, without departing from the scope and spirit of the invention.

In another alternative embodiment, the functionality of a particular user device may is made to change depending on which vehicle the user device is used in. In this case, the vehicle contains an ad hoc network device, and a particular user device, such as a pager or mobile phone is also an ad hoc network device. When the user device discovers the vehicle, it changes its functionality. For example, a truck driver may carry a mobile telephone. When the telephone is placed in the truck driver's truck, it reports billing information with regard to the driver's trucking business; when the telephone is placed in the truck driver's personal car, however, it reports personal billing information instead. As another example, a driver may wish to keep track of the fuel economy of several vehicles. The user device may be made to keep records of fuel purchased using the device for one vehicle as opposed to another vehicle.

The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
discovering, in an ad hoc network, a device associated with an operator of a vehicle;
responsive to discovering the device, adding the device to the ad hoc network;
obtaining, from the device, billing information regarding the operator; and
billing the operator for a service related to the vehicle.

2. The method of claim 1, wherein the ad hoc network is one of a Bluetooth network and an IEEE 802.11 network.

3. The method of claim 1, wherein the device forms part of the vehicle.

4. The method of claim 1, wherein the device is one of a mobile telephone, a pager, and a personal digital assistant.

5. The method of claim 1, wherein the service is one of parking, use of a toll road, and payment of a traffic fine.

6. The method of claim 1, further comprising:
transmitting client code to the device.

7. The method of claim 1, further comprising:
transmitting a form in a structured markup language to the device.

8. A method operative in a user device, comprising:
discovering an ad hoc network;
joining the ad hoc network; and
transmitting billing information associated with an operator of a vehicle for payment for a vehicle-related service.

9. The method of claim 8, wherein the service is one of parking, use of a toll road, and a traffic fine.

10. The method of claim 8, wherein the ad hoc network is one of a Bluetooth network and an IEEE 802.11 network.

11. The method of claim 8, further comprising:
receiving client code for execution.

12. The method of claim 8, further comprising:
receiving a form in a structured markup language for obtaining additional billing information;
receiving the additional billing information; and
transmitting the additional billing information.

13. The method of claim 8, further comprising:
discovering an ad hoc network node associated with the vehicle; and
changing the functionality of the user device in response to discovering the ad hoc network node.

14. A computer program product in a computer-readable medium, comprising instructions for:
discovering, in an ad hoc network, a device associated with an operator of a vehicle;
responsive to discovering the device, adding the device to the ad hoc network;
obtaining, from the device, billing information regarding the operator; and
billing the operator for a service related to the vehicle.

15. The computer program product of claim 14, wherein the ad hoc network is a Bluetooth network.

16. The computer program product of claim 14, wherein the device forms part of the vehicle.

17. The computer program product of claim 14, wherein the device is one of a mobile telephone, a pager, and a personal digital assistant.

18. The computer program product of claim 14, wherein the service is one of parking, use of a toll road, and payment of a traffic fine.

19. The computer program product of claim 14, comprising additional instructions for:
transmitting client code to the device.

20. The computer program product of claim 14, comprising additional instructions for:
transmitting a form in a structured markup language to the device.

21. A computer program product in a computer-readable medium for use in a user device, comprising instructions for:
discovering an ad hoc network;
joining the ad hoc network; and
transmitting billing information associated with an operator of the vehicle for payment for a vehicle-related service.

22. The computer program product of claim 21, wherein the service is one of parking, use of a toll road, and a traffic fine.

23. The computer program product of claim 21, wherein the ad hoc network is one of a Bluetooth network and an IEEE 802.11 network.

24. The computer program product of claim 21, comprising additional instructions for:
receiving client code for execution.

25. The computer program product of claim 21, comprising additional instructions for:
receiving a form in a structured markup language for obtaining additional billing information;
receiving the additional billing information; and
transmitting the additional billing information.

26. The computer program product of claim 21, comprising additional instructions for:
discovering an ad hoc network node associated with the vehicle; and
changing the functionality of the user device in response to discovering the ad hoc network node.

27. A data processing system comprising:
a bus system;
a processing unit, including at least one processor and connected to the bus system;
memory attached to the bus system;
a set of instructions in the memory,
wherein the processing unit executes the set of instructions to perform the acts of:
discovering, in an ad hoc network, a device associated with an operator of a vehicle;
responsive to discovering the device, adding the device to the ad hoc network;
obtaining, from the device, billing information regarding the operator; and
billing the operator for a service related to the vehicle.

28. The data processing system of claim 27, wherein the ad hoc network is one of a Bluetooth network and an IEEE 802.11 network.

29. The data processing system of claim 27, wherein the device forms part of the vehicle.

30. The data processing system of claim 27, wherein the device is one of a mobile telephone, a pager, and a personal digital assistant.

31. The data processing system of claim 27, wherein the service is one of parking, use of a toll road, and payment of a traffic fine.

32. The data processing system of claim 27, wherein the processing unit executes the set of instructions to perform the additional act of:
transmitting client code to the device.

33. The computer program of claim 27, wherein the processing unit executes the set of instructions to perform the additional act of:
transmitting a form in a structured markup language to the device.

34. A data processing system comprising:
a bus system;
a processing unit, including at least one processor and connected to the bus system;
memory attached to the bus system;
a set of instructions in the memory,
wherein the processing unit executes the set of instructions to perform the acts of:
discovering an ad hoc network;
joining the ad hoc network; and
transmitting billing information associated with an operator of a vehicle for payment for the service.

35. The data processing system of claim 34, wherein the service is one of parking, use of a toll road, and payment of a traffic fine.

36. The data processing system of claim 34, wherein the ad hoc network is one of a Bluetooth network and an IEEE 802.11 network.

37. The data processing system of claim 34, wherein the processing unit executes the set of instructions to perform the additional act of:
receiving client code for execution.

38. The data processing system of claim 34, wherein the processing unit executes the set of instructions to perform the additional act of:
receiving a form in a structured markup language for obtaining additional billing information;
receiving the additional billing information; and
transmitting the additional billing information.

39. The data processing system of claim 34, wherein the processing unit executes the set of instructions to perform the additional acts of:
discovering an ad hoc network node associated with the vehicle; and
changing the functionality of the data processing system in response to discovering the ad hoc network node.
